(19) United States
(12) Patent Application Publication
(10) Pub. No.: US 2024/0022900 A1
(43) Pub. Date: Jan. 18, 2024

(54) EMBEDDED SUBSCRIBER IDENTITY MODULE ACTIVATION OVER PEER-TO-PEER CONNECTION

(71) Applicant: SAMSUNG ELECTRONICS CO., LTD., Gyeonggi-Do (KR)

(72) Inventor: Rajeshkumar Somasekhar, Neshanic Station, NJ (US)

(21) Appl. No.: 18/149,543

(22) Filed: Jan. 3, 2023

Related U.S. Application Data
(60) Provisional application No. 63/388,761, filed on Jul. 13, 2022.

(51) Int. Cl. H04W 8/26; H04W 8/20

(52) U.S. Cl. CPC H04W 8/265; H04W 8/20

(57) ABSTRACT

eSIM activation using peer-to-peer (P2P) communication includes receiving by an eSIM-capable device an eSIM profile from another device, the eSIM profile retrieved from a subscription manager data preparation (SMDP) server via a network. The eSIM profile is received by the eSIM-capable device from the other device via the P2P connection. The eSIM-capable device performs an eSIM activation based on the eSIM profile from the other device.

### CROSS-REFERENCE TO RELATED APPLICATIONS

This application claims the benefit of U.S. Provisional Patent Application No. 63/388,761 filed on Jul. 13, 2022, which is incorporated herein by reference in its entirety.

### TECHNICAL FIELD

This disclosure relates to wireless communications, and more particularly, to activating an embedded subscriber identity module (eSIM) on an eSIM-capable device.

### BACKGROUND

An eSIM comprises software installed on an embedded universal integrated circuit card (eUICC), which is permanently installed in a device. The eSIM is an alternative to a conventional SIM, which detachably inserts in the device. Activating an eSIM subscription requires coupling the eSIM-capable device to a wireless service provider's subscription manager data preparation (SMDP) server over a data communications network and downloading to the device an eSIM profile. Thus, whereas a conventional SIM can be activated by inserting a SIM card into a device without connecting the device to a server via a data communications network, eSIM activation requires connecting the eSIM-capable device to an SMDP server via the Internet or other data communications network.

### SUMMARY

In an example implementation, a method of eSIM activation on an eSIM-capable device may include receiving by the eSIM-capable device an eSIM profile from another device via a peer-to-peer (P2P) connection, the eSIM profile retrieved from a subscription manager data preparation (SMDP) server via a network. The method may include performing an eSIM activation based on the eSIM profile from the other device.

In another example implementation, a device comprises an embedded universal integrated circuit card (eUICC). The eUICC may be configured to initiate operations including receiving an eSIM profile from another device via a peer-to-peer (P2P) connection, the eSIM profile retrieved from a subscription manager data preparation (SMDP) server via a network. The operations may include performing an eSIM activation based on the eSIM profile from the other device.

In yet another example implementation, a device comprises one or more processors which execute a proxy local profile assistant (LPA). The one or more processors of the device are configured to initiate operations. The operations may include receiving from a wireless service provider server via a network an eSIM profile corresponding to an eSIM-capable device. The operations may include conveying via peer-to-peer (P2P) connection the eSIM profile to the eSIM-capable device.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system configured to facilitate activating an eSIM on an eSIM-capable device free of the device's having to connect to a network.

FIG. 2 illustrates an example exchange of messages and device actions for activating an eSIM on an eSIM-capable device free of the device's having to connect to a network.

FIG. 3 illustrates an example exchange of messages using GSMA-defined ES9+ and ES10b APIs for activating an eSIM on an eSIM-capable device.

FIG. 4 illustrates an example method of activating an eSIM on an eSIM-capable device free of the device's having to connect to a network.

FIG. 5 illustrates an example device configured for operation as an eSIM-capable device.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to wireless communications, and more particularly, to activating an eSIM on an eSIM-capable device. As already noted, a conventional SIM detachably inserts into a device, with the SIM subscription being activated when the SIM is inserted in the device. Activating the eSIM using current technology, however, requires coupling (e.g., communicatively coupling) the eSIM-capable device to a wireless service provider's SMDP server over a network for downloading an eSIM profile. Thus, activation on the eSIM-capable device requires that the device connect to an SMDP server via the Internet or other network. The requirement may be problematic. For example, if a Wi-Fi or other connection for connecting with the Internet is unavailable, the eSIM-capable device cannot perform an eSIM activation. The lack of a viable connection precludes access to and downloading from the SMDP server the data (eSIM profile) necessary for facilitating the eSIM activation.

In accordance with the inventive arrangements described within this disclosure, example methods, systems, and device configurations are provided that are capable of facilitating eSIM activation on an eSIM-capable device without the device connecting to the Internet or other network and without directly connecting to an SMDP server. The eUICC of the eSIM-capable device, in accordance with the inventive arrangements disclosed herein, receives an eSIM profile and eUICC management commands over a peer-to-peer (P2P) connection. The eSIM profile and eUICC management commands enable the eSIM-capable device to perform an eSIM activation without the eSIM-enabled device coupling to a network or connecting directly to the SMDP. As also defined herein, an “eSIM-capable device” is a device in which an eUICC is fixedly integrated in the device to enable the device to connect to a wireless service provider's mobile network once an eSIM subscription is activated.

In one or more implementations, another, e.g., external, device serves as a proxy for the eSIM-capable device, which assumes the role of a target device. The other device downloads the content of the target device's eSIM profile from a wireless service provider's SMDP server. The other device pushes the eSIM profile and eUICC management commands to the target device via a P2P connection.

In one aspect, the eSIM profile and eUICC management commands are wirelessly pushed to the target device by the other device using come-to-attention (AT) commands. The AT commands embed eSIM profile content and eUICC management commands therein and are conveyed over the P2P connection between the other and target devices. The other device embeds the eSIM profile content and eUICC management commands within AT commands. The target eSIM-capable device extracts the eUICC management commands from the AT commands.

The inventive arrangements, for example, can facilitate a point-of-sale (POS) eSIM activation at a wireless service operator's store. A store employee may scan a device for equipment details and create an eSIM subscription for the device at the store. Downloading and installing the newly created eSIM profile to the device requires that the device connect to the Internet via a Wi-Fi or other network, but for various reasons, the store's policy may prohibit the device's accessing a network via Wi-Fi to facilitate eSIM activation. Moreover, connecting the device to the network and performing the activation consumes time. To alleviate the problem, the inventive arrangements can be implemented with a store-based device to which the user device can couple via a wired (e.g., plug-in) or wireless connection for downloading the eSIM profile to the user device.

The inventive arrangements can facilitate an eSIM transfer from an older eSIM-capable device to a new one, for example. The older device can use any available method to request an activation code from a wireless service provider for eSIM subscription transfer to the new device. Once the activation code is received, the older device can be used to connect with the wireless service provider's SMDP server using the eUICC credentials of the new device with the older device's LPA serving as a proxy for the new device's eUICC. The eSIM profile content can be downloaded from the SMDP server to the older device and pushed to the new device over a P2P connection.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

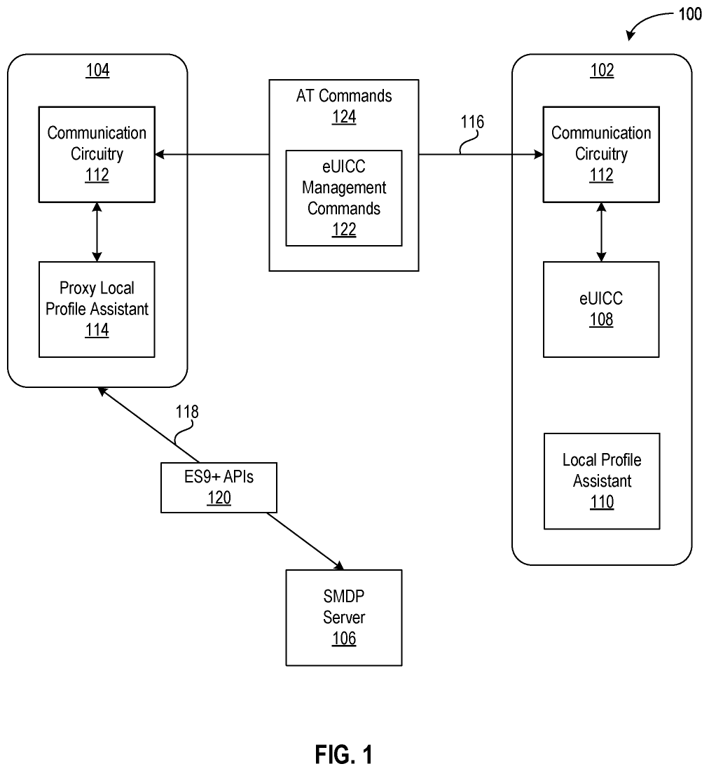

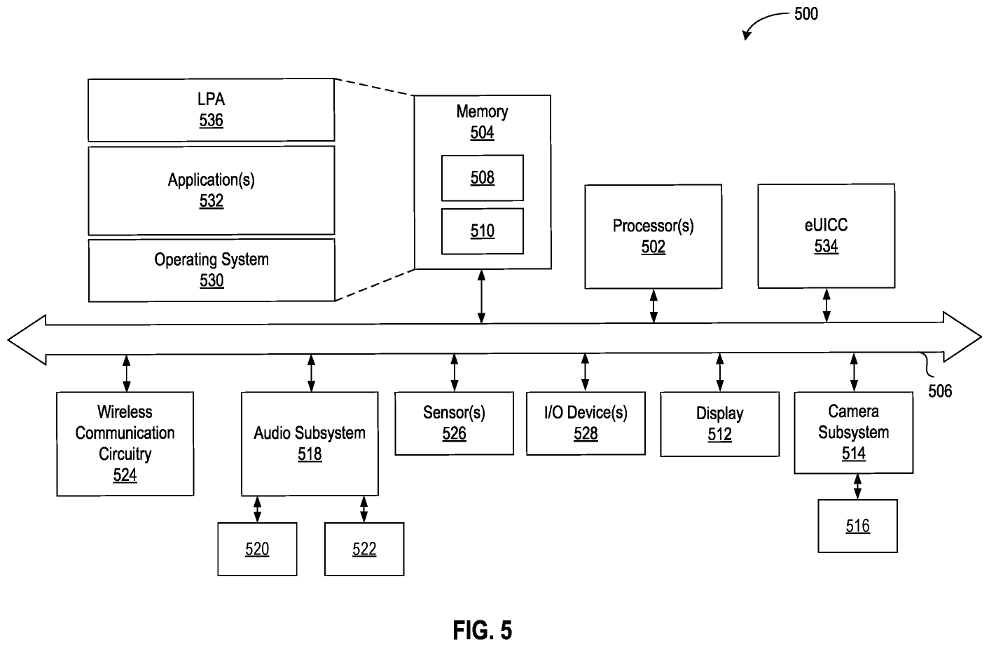

FIG. 1 illustrates an example communication system 100 configured to facilitate eSIM activation. Illustratively, system 100 includes eSIM-capable device 102, another device 104, and SMDP server 106 of a wireless service operator. In various implementations, eSIM-capable device 102 can be any wireless device, such as a smartphone, wearable, computer (e.g., PC), or the like. eSIM-capable device 102 can include all or any combination of the different components described with respect to example device 500 described in the context of FIG. 5. Illustratively, eSIM-capable device 102 includes eUICC 108, LPA 110, and communication circuitry 112. Communication circuitry 112 can include one or more wireless communication subsystems, such as wireless communication subsystem(s) 524. (See FIG. 5.) Other device 104 illustratively includes an LPA that, in the present context, serves as proxy LPA 114. Other device 104 also illustratively includes communication circuitry 112. Other device 104 can, but need not, include an eUICC. For example, in some arrangements, other device 104 is a POS device to which eSIM-capable device 102 plugs into or to which eSIM-capable device 102 connects wirelessly. In other arrangements, other device 104 is itself an eSIM-capable device and includes an eUICC. In any case, in the context of system 100, other device 104 includes proxy LPA 114. System 100 facilitates eSIM-capable device 102's eSIM activation free of (e.g., without) eSIM-capable device 102 connecting to a network or directly to SDMP 106.

In one or more aspects, a “network” refers to a collection of multiple nodes in which data is transferred from one node to another node through one or more intervening nodes (e.g., in in multiple wired or wireless hops). Accordingly, a network connection refers the transfer of data from one node to another through one or more intervening nodes of the network. In one or more aspects, a “P2P connection” is direct channel or link between at least two communication devices whereby data is exchanged between the two devices without traversing any intermediate nodes and/or devices.

Operatively, eUICC 108 of eSIM-capable device 102 couples with proxy LPA 114 of other device 104. The coupling can be via a P2P connection 116 that is established between eUICC 108 and proxy LPA 114. Via P2P connection 116, eUICC 108 receives an eSIM profile from proxy LPA 114. Proxy LPA 114 retrieves the eSIM profile from SMDP server 106 via a wired or wireless connection to network 118, through which proxy LPA 114 couples with SMDP server 106.

In certain embodiments, communication between proxy LPA 114 and SMDP server 106 can be over an HTTPS session. The HTTPS session can be conducted via a wired or wireless connection to network 118 through which proxy LPA 114 couples with SMDP server 106. The communication, in certain embodiments, uses ES9+ APIs 120 defined in the GSMA SGP.22 API specification. Using GSMA-defined ES9+ APIs, proxy LPA 114 can exchange data with SMDP server 106, which generates all the required data for installing the eSIM profile on eSIM-capable device 102. Proxy LPA 114, in certain embodiments, exchanges eUICC management commands 122 implemented as GSMA-defined ES10 APIs over P2P connection 116 with eUICC 108.

Using the eSIM profile received from proxy LPA 114 over P2P connection 116, eUICC 108 activates an eSIM subscription. The eSIM operations are then available through the wireless service provider for eSIM-capable device 102. Thus, in response to receiving by eUICC 108 of eSIM-capable device 102 the eSIM profile, the eSIM activation is performed over a P2P connection without eSIM-capable device 102 ever having had to couple directly with any network or fetching the eSIM profile from SMDP server 106 directly.

In certain embodiments, eUICC 108 of eSIM-capable device 102 receives eUICC management commands 122 (e.g., GSMA-defined ES10 APIs) embedded in AT commands 124, which are modem-controlling commands. Other device 104 embeds the eUICC management commands received from SMDP server 106 within AT commands 124. Upon receiving AT commands 124, eUICC 108 extracts and executes each of the embedded eUICC management commands for performing the eSIM activation.

The eSIM activation is performed by eUICC 108 of eSIM-capable device 102 through the exchange of eUICC management commands with proxy LPA 114. The eSIM activation is performed without eUICC 108 exchanging data with LPA 110 of eSIM-capable device 102. Instead, eUICC 108 performs the eSIM activation by bypassing LPA 110 of eSIM-capable device 102.

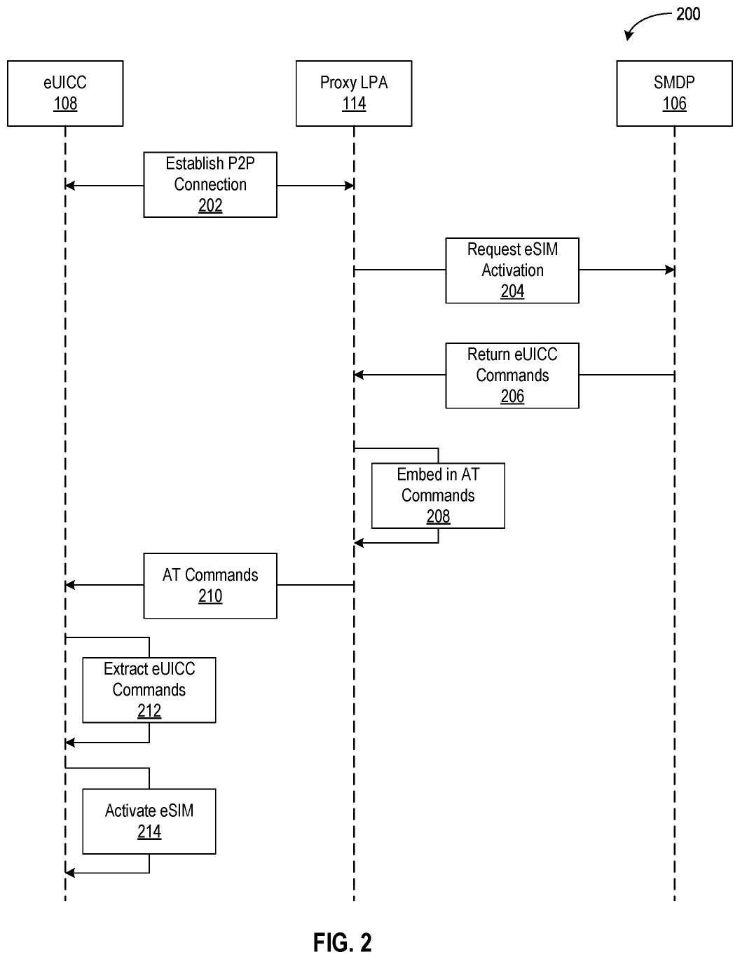

FIG. 2 illustrates example exchanges of messages and device actions 200. Message exchanges and device actions 200 involve eSIM-capable device 102 and other device 104 and SMDP server 106, which engage in activating an eSIM on eSIM-capable device 102 free of the device directly connecting to a network or SMDP server 106. Initially, at block 202, eUICC 108 of eSIM-capable device 102 and proxy LPA 114 of other device establish a P2P connection, over which device-related information is acquired by proxy LPA 114 regarding eSIM-capable device 102. The device-related information acquired by proxy LPA 114 over the P2P connection includes eUICC 108-specific information needed by SMDP server 106 for a data exchange (e.g., part of an ES9 protocol exchange) with proxy LPA 114.

At block 204, proxy LPA 114 conveys to SMDP server 106 a request for the eSIM activation with the device-related information. SMDP server 106 uses the device-related information to generate eUICC management commands 122, including an eSIM profile management command for downloading an eSIM profile package to eUICC 108. The package includes the eSIM profile, which is specific to the wireless service provider, or mobile network operator (MNO). The content of the eSIM profile is written to the device eUICC chipset, eUICC 108 of eSIM-capable device 102, and corresponds to subscriber information and network connectivity parameters.

At block 206, SMDP server 106 conveys eUICC commands to proxy LPA 114. Proxy LPA 114 embeds the eUICC commands in AT commands at block 208. At block 210, proxy LPA 114 conveys the AT commands to eUICC 108. The eUICC commands are extracted from the AT commands by eUICC 108 at block 212. At block 214, eUICC 108 activates the eSIM by executing the extracted eUICC commands.

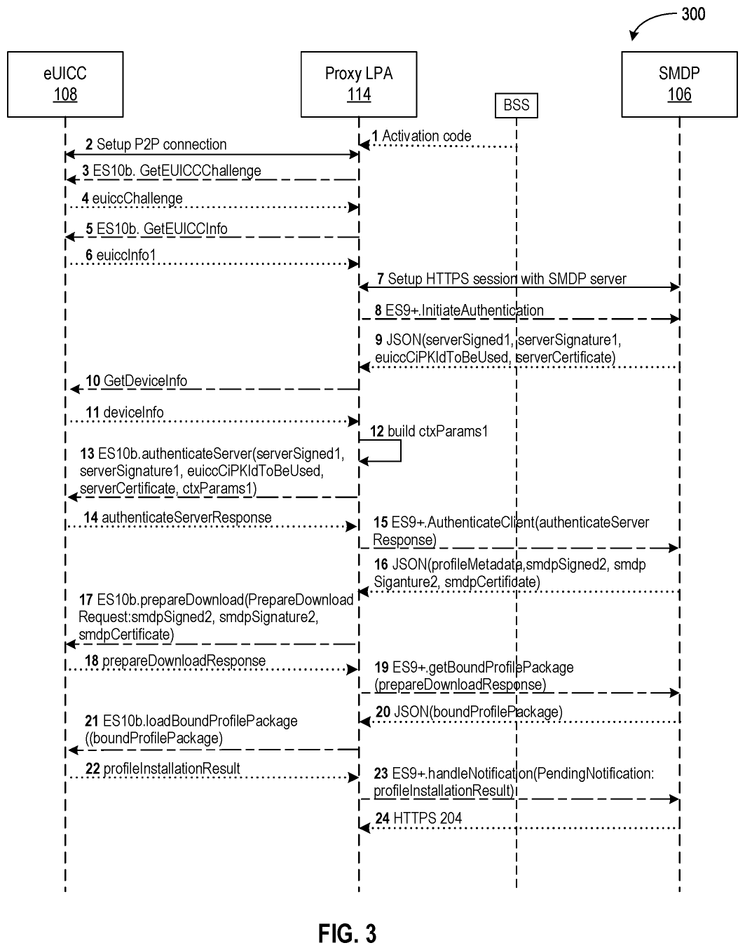

FIG. 3 illustrates example exchanges of messages 300 using GSMA-defined ES9+ and ES10b APIs. The messages are exchanged between eUICC 108 of eSIM-capable device 102 and proxy LPA 114 of other device 104 and SMDP server 106. Although not explicitly shown, one or more of the messages can be conveyed as an AT command, and subsequently, the information conveyed can be extracted from the AT command upon its receipt.

Initially, message 1 from basic services set (BSS) of the wireless service provider conveys an activation code to proxy LPA 114. Mutual message exchanges 2 establish a P2P connection between proxy LPA 114 and eUICC 108. ES10b.GetEUICCChallenge API is conveyed in message 3 from proxy LPA 114 to eUICC 108, which responds with message 4. ES10b.GetEUICCInfo API is conveyed in message 5 from proxy LPA 114 to eUICC 108, which responds with message 6. Mutual message exchanges 7 between proxy LPA 114 and SMDP server setup an HTTPS session. Proxy LPA 114 conveys ES9+. InitiateAuthentication request to SMDP server in message 8. Message 9 conveys data in the JSON format from SMDP server to proxy LPA 114. Proxy LPA 114 issues a command for device information in message 10 to eUICC 108, which responds with message 11. Proxy LPA 114, at 12, builds cts parameters relevant to the eSIM activation. Message 13 from Proxy LPA 114 conveys ES10b.authenticateServer API to eUICC 108. A response from eUICC 108 is conveyed in message 14. Proxy LPA 114 in message 15 conveys ES9+.AuthenticateClient API to SMDP server 106, which responds with JSON-formatted data in message 16. Proxy LPA 114 in message 17 conveys ES10B.prepareDownload API to eUICC 108, and in message 18, eUICC responds. Proxy LPA 114 in message 19 conveys ES9+.getBoundProfilePackage API, to which SMDP 106 responds by conveying JSON-formatted data in message 20. Message 21 from LPA 114 to eUICC 108 conveys ES10b.loadBoundProfilePackage API, to which eUICC 108 responds with message 22. Proxy LPA 114 conveys ES9+.handleNotification API to SMDP server 106 in message 23. SMDP server 106 responds with message 24 initiating HTTPS session for conveying eUICC commands for eSIM activation.

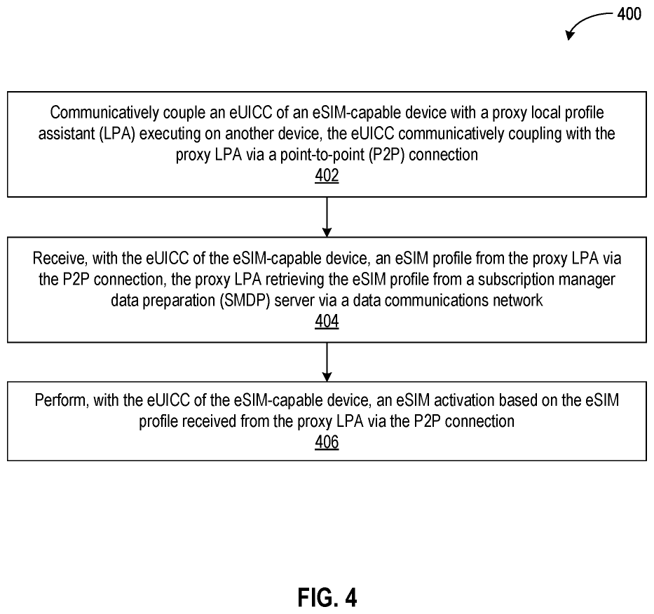

FIG. 4 illustrates example method 400 of eSIM activation by a device free of a direct connection with a network. Method 400 can be implemented with an eSIM capable device, such as eSIM-capable device 102, having an eUICC (e.g., eUICC 108) for connecting with a proxy LPA (e.g., proxy LPA 114) of another device (e.g., other device 104).

At block 402, an eUICC of the eSIM-capable device couples with a proxy local profile assistant (LPA) executing on another device. The eUICC couples with the proxy LPA via a peer-to-peer (P2P) connection.

At block 404, the eUICC of the eSIM-capable device receives an eSIM profile from the proxy LPA via the P2P connection. The proxy LPA retrieves the eSIM profile from a subscription manager data preparation (SMDP) server via a network.

At block 406, the eUICC of the eSIM-capable device performs an eSIM activation based on the eSIM profile received from the proxy LPA via the P2P connection. Accordingly, in certain embodiments, the eUICC of the eSIM-capable device is capable of receiving the eSIM profile over the P2P connection. The eUICC is capable of performing the eSIM activation without coupling to the network.

In certain embodiments, the eUICC of the eSIM-capable device is configured to exchange eUICC management commands with the proxy LPA via the P2P connection. The UICC management commands, in some embodiments, are exchanged embedded in AT commands conveyed via the P2P connection. If the UICC management commands are embedded in one or more AT commands, the eUICC of the eSIM-capable device can be configured to extract the eUICC management commands from the AT commands.

The eUICC of the eSIM-capable device can be configured to exchange commands with the proxy LPA and to perform the eSIM activation by bypassing an LPA of the eSIM-capable device.

FIG. 5 illustrates an example device 500 which can be configured for operation as an eSIM-capable device. Illustratively, device 500 includes one or more processors 502 coupled to memory 504 through interface circuitry 506. Device 500 stores computer readable instructions (also referred to as “program code”) within memory 504, which is an example of computer readable storage media. Processor(s) 502 execute the program code accessed from memory 504 via interface circuitry 506.

Memory 504 can include one or more physical memory devices such as local memory 508 and bulk storage device 510, for example. Local memory 508 is implemented as one or more non-persistent memory device(s) generally used during actual execution of the program code. Local memory 508 is an example of a runtime memory. Examples of local memory 508 include any of the various types of RAM suitable for use by a processor for executing program code. Bulk storage device 510 is implemented as a persistent data storage device. Examples of bulk storage device 510 include a hard disk drive (HDD), a solid-state drive (SSD), flash memory, a read-only memory (ROM), an erasable programmable read-only memory (EPROM), electrically erasable programmable read-only memory (EEPROM), or other suitable memory. Device 500 can also include one or more cache memories (not shown) that provide temporary storage of at least some program code in order to reduce the number of times program code must be retrieved from a bulk storage device during execution.

Examples of interface circuitry 506 include, but are not limited to, an input/output (I/O) subsystem, an I/O interface, a bus system, and a memory interface. For example, interface circuitry 506 can be implemented as any of a variety of bus structures and/or combinations of bus structures including a memory bus or memory controller, a peripheral bus, an accelerated graphics port, and a processor or local bus.

In one or more example implementations, processor(s) 502, memory 504, and/or interface circuitry 506 are implemented as separate components. Processor(s) 502, memory 504, and/or interface circuitry 506 may be integrated in one or more integrated circuits. The various components in device 500, for example, can be coupled by one or more communication buses or signal lines (e.g., interconnects and/or wires). Memory 504 may be coupled to interface circuitry 506 via a memory interface, such as a memory controller or other memory interface (not shown).

Device 500 can include one or more displays. Illustratively, for example, device 500 includes display 512 (e.g., a screen). If device 500 is configured as an HMD, for example, display 512 can be a monocular HMD comprising a single optic or a binocular HMD comprising an optic in front of each eye. As an HMD, display 512 can comprise lenses and semi-transparent mirrors embedded in eyeglasses (also termed data glasses), a visor, or a helmet. Display 512 can be implemented as a touch-sensitive or touchscreen display capable of receiving touch input from a user. A touch sensitive display and/or a touch-sensitive pad is capable of detecting contact, movement, gestures, and breaks in contact using any of a variety of avail, able touch sensitivity technologies. Example touch sensitive technologies include, but are not limited to, capacitive, resistive, infrared, and surface acoustic wave technologies, and other proximity sensor arrays or other elements for determining one or more points of contact with a touch sensitive display and/or device.

Device 500 can include camera subsystem 514. Camera subsystem 514 can be coupled to interface circuitry 506 directly or through a suitable input/output (I/O) controller. Camera subsystem 514 can be coupled to optical sensor 516. Optical sensor 516 can be implemented using any of a variety of technologies. Examples of optical sensor 516 can include, but are not limited to, a charged coupled device (CCD) or a complementary metal-oxide semiconductor (CMOS) optical sensor. Optical sensor 516, for example, can be a depth sensor. Camera subsystem 514 and optical sensor 516 are capable of performing camera functions such as recording or capturing images and/or recording video.

Device 500 can include an audio subsystem 518. Audio subsystem 518 can be coupled to interface circuitry 506 directly or through a suitable input/output (I/O) controller. Audio subsystem 518 can be coupled to a speaker 520 and a microphone 522 to facilitate voice-enabled functions, such as voice recognition, voice replication, digital recording, and telephony functions. Device 500 can include one or more wireless communication subsystems 524. Each of wireless communication subsystem(s) 524 can be coupled to interface circuitry 506 directly or through a suitable I/O controller (not shown). Each of wireless communication subsystem(s) 524 is capable of facilitating communication functions. Examples of wireless communication subsystems 524 can include, but are not limited to, radio frequency receivers and transmitters, and optical (e.g., infrared) receivers and transmitters. The specific design and implementation of wireless communication subsystem 524 can depend on the particular type of device 500 implemented and/or the communication network(s) over which device 500 is intended to operate.

As an illustrative and non-limiting example, wireless communication subsystem(s) 524 may be designed to operate over one or more mobile networks, Wi-Fi networks, short range wireless networks (e.g., a Bluetooth), and/or any combination of the foregoing. Wireless communication subsystem(s) 524 can implement hosting protocols such that device 500 can be configured as a base station for other wireless devices.

Device 500 may include one or more sensors 526, each of which can be coupled to interface circuitry 506 directly or through a suitable I/O controller (not shown). Examples of sensor(s) 526 that can be included in device 500 include, but are not limited to, a motion sensor, a light sensor, and a proximity sensor to facilitate orientation, lighting, and proximity functions, respectively, of device 500. Other examples of sensors 526 can include, but are not limited to, a location sensor (e.g., a GPS receiver and/or processor) capable of providing geo-positioning sensor data, an electronic magnetometer (e.g., an integrated circuit chip) capable of providing sensor data that can be used to determine the direction of magnetic North for purposes of directional navigation, an accelerometer capable of providing data indicating change of speed and direction of movement of device 500 in 3D, and an altimeter (e.g., an integrated circuit) capable of providing data indicating altitude.

Device 500 further may include one or more input/output (I/O) devices 528 coupled to interface circuitry 506. I/O device(s) 528 can be coupled to interface circuitry 506 either directly or through intervening I/O controllers (not shown). Examples of I/O devices 528 include, but are not limited to, a track pad, a keyboard, a display device, a pointing device, one or more communication ports (e.g., Universal Serial Bus (USB) ports), a network adapter, and buttons or other physical controls. A network adapter refers to circuitry that enables device 500 to become coupled to other systems, computer systems, remote printers, and/or remote storage devices through intervening private or public networks. Modems, cable modems, Ethernet interfaces, and wireless transceivers not part of wireless communication subsystem(s) 524 are examples of different types of network adapters that may be used with device 500. One or more of I/O devices 528 may be adapted to control functions of one or more or all of sensors 526 and/or one or more of wireless communication subsystem(s) 524.

Memory 504 stores program code. Examples of program code include, but are not limited to, routines, programs, objects, components, logic, and other data structures. For purposes of illustration, memory 504 stores an operating system 530 and application(s) 532

As an example eSIM-capable device, device 500 additionally includes eUICC 534, which operatively couples with other components through interface circuitry 506. Device 500, as an eSIM-capable device also includes LPA 536, implemented in software stored in memory 504.

Device 500 is provided for purposes of illustration and not limitation. A device and/or system configured to perform the operations described herein can have a different architecture than illustrated in FIG. 5. The architecture can be a simplified version of the architecture described in connection with FIG. 5 that includes a memory capable of storing instructions and a processor capable of executing instructions. In this regard, device 500 may include fewer components than shown or additional components not illustrated in FIG. 5 depending upon the particular type of device that is implemented. In addition, the particular operating system and/or application(s) included can vary according to device type as can the types of I/O devices included. Further, one or more of the illustrative components can be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method, comprising:
receiving by an eSIM-capable device an eSIM profile from another device via a peer-to-peer (P2P) connection, wherein the eSIM profile is retrieved from a subscription manager data preparation (SMDP) server via a network; and
performing an eSIM activation based on the eSIM profile from the other device.

2. The method of claim 1, further comprising:
coupling an eUICC of the eSIM-capable device with a proxy local profile assistant (LPA) executing on the other device, wherein the eUICC couples with the proxy LPA via the P2P connection.

3. The method of claim 1, wherein the eSIM-capable device receives the eSIM profile and performs the eSIM activation without coupling to the network.

4. The method of claim 1, wherein the eSIM-capable device is configured to exchange eUICC management commands with a proxy local profile assistant executing on the other device, and wherein the eUICC management commands are exchanged via the P2P connection.

5. The method of claim 4, wherein the eUICC management commands exchanged are embedded in come-to-attention (AT) commands conveyed via the P2P connection.

6. The method of claim 5, further comprising:
extracting the eUICC management commands from the AT commands.

7. The method of claim 1, wherein the eSIM-capable device exchanges commands with a proxy LPA executing on the other device and performs the eSIM activation by bypassing a proxy local profile assistant of the eSIM-capable device.

8. A device, comprising:
an embedded universal integrated circuit card (eUICC), configured to initiate operations including:
receiving an eSIM profile from another device via a peer-to-peer (P2P) connection, wherein the eSIM profile is retrieved from a subscription manager data preparation (SMDP) server via a network; and
performing an eSIM activation based on the eSIM profile from the other device.

9. The device of claim 8, wherein the eUICC is configured to initiate operations further including:
coupling with a proxy local profile assistant (LPA) executing on the other device, wherein the eUICC couples with the proxy LPA via the P2P connection.

10. The device of claim 8, wherein the eUICC receives the eSIM profile and performs the eSIM activation without coupling to the network.

11. The device of claim 8, wherein the eUICC is capable of exchanging eUICC management commands with a proxy local profile assistant executing on the other device, and wherein the eUICC management commands are exchanged via the P2P connection.

12. The device of claim 11, wherein the eUICC management commands exchanged are embedded in come-to-attention (AT) commands conveyed via the P2P connection.

13. The device of claim 12, wherein eUICC is configured to initiate operations further including extracting the eUICC management commands from the AT commands.

14. The device of claim 8, wherein the eUICC exchanges commands with a proxy local profile assistant executing on the other device and performs the eSIM activation by bypassing an LPA of the device.

15. A device, comprising:
one or more processors which execute a proxy local profile assistant (LPA), wherein the one or more processors are configured to initiate operations including:
receiving from a wireless service provider server via a network an eSIM profile corresponding to an eSIM-capable device; and
conveying via a peer-to-peer (P2P) connection the eSIM profile to the eSIM-capable device.

16. The device of claim 15, wherein the one or more processors are configured to initiate operations further including:
coupling the proxy LPA with an eUICC of the eSIM-capable device via the P2P connection; and
conveying the eSIM profile to the eUICC of the eSIM-capable device via the P2P connection between the proxy LPA and the eUICC.

17. The device of claim 15, wherein the eSIM profile enables the eSIM-capable device to activate an eSIM subscription created by the wireless service provider without the eSIM-capable device coupling to the network.

18. The device of claim 15, wherein the proxy LPA is configured to exchange eUICC management commands with an eUICC of the eSIM-capable device via the P2P connection.

19. The device of claim 18, wherein the proxy LPA is configured to embed the eUICC management commands exchanged in come-to-attention (AT) commands conveyed via the P2P connection.

20. The device of claim 15, wherein the proxy LPA is configured to operate as a proxy in place of an LPA of the eSIM-capable device, and wherein the proxy LPA is configured to exchange commands with an eUICC of the eSIM-capable device bypassing the LPA of the eSIM-capable device.
